(19) United States
(12) Patent Application Publication
(10) Pub. No.: US 2019/0014935 A1
(43) Pub. Date: Jan. 17, 2019

(54) Mountable holder assembly for beverage holders and accessories

(71) Applicant: Caddy Products, Inc., Palm Desert, CA (US)

(72) Inventor: Peter W.A. Bergin, Rancho Mirage, CA (US)

(21) Appl. No.: 15/648,148

(22) Filed: Jul. 12, 2017

(51) Int. Cl. A47G 23/02; A47C 7/68; A47G 1/00; A47G 29/08; G09F 23/00

(52) U.S. Cl. CPC A47G 23/02; A47C 7/68; G09F 23/00; A47G 29/083; A47G 1/00

(57) ABSTRACT

A mountable holder assembly including a combination holder that is a beverage container holder, a mobile device holder and a holder for a bag strap. The mountable holder assembly is mountable to a wall or other substantially vertical surface. The mountable holder assembly is a base portion having integrally formed vertical walls which provide perimeters for the beverage container holder, the mobile device holder and also includes an extension or arm section for holding a bag via its strap. The base portion is configured for holding the beverage container in a substantially vertical position. A mounting frame includes an area for mounting a display near or with the combination holder, where the display is an advertisement, informational material or a mirror.

### BACKGROUND

The present invention relates to a mountable holder assembly. More specifically, the present invention relates to a combination holder assembly for a beverage container and multiple accessories.

Sports facilities, concert venues, and other public performance venues include beverage container holders attached to seat backs. Patrons bring their beverage or other belongings with them when they use the restroom. It is common for these patrons to ask a companion to hold their drink, their phone and/or their purse as there is no place to store these items without leaving them behind at their seat. At most, there may be a hook secured to the door inside the bathroom stall at these venues, and many times, the hooks are missing as they have fallen off or otherwise been removed.

Public restrooms, such as those in malls or the airport also only have a hook or a shallow ledge within the bathroom stall for holding a users goods. Again, the hooks may have been inadvertently removed or are otherwise missing. The ledges are shallow such that these ledges cannot be used to hold many items without fear or knocking the item in a toilet or a sink, or onto the floor.

### SUMMARY

An aspect of the present disclosure relates to a mountable holder assembly, where the assembly includes a combination holder. The combination holder comprises a beverage container holder, a mobile device holder and a holder for a bag strap. The mountable holder assembly is mountable to a mounting surface. The mounting surface may be substantially flat such a wall or other substantially vertical surface. For example, the mountable holder assembly can be secured to a wall, or to a door, such as those in a public restroom, near a concession stand in a public facility or on any substantially flat and substantially vertical surface. The mountable holder assembly can be secured to, without limit, substantially any surface, including near work benches, on seat substantially flat seat backs, or other areas where a mountable combination beverage and accessory hold may be utilized. The mountable holder may be configured with a mounting piece configured to secure the mountable holder to additional mounting spaces, such as those that are not traditionally viewed as being substantially flat, such as between seat backs of stadium seating.

The mountable holder assembly includes a base portion having integrally formed vertical walls which provide perimeters for the beverage container holder, the mobile device holder also includes an extension or prong for holding a bag via its strap. The base portion is configured for holding the beverage container in a substantially vertical position.

The base portion is securable to the mounting surface (e.g., wall, post, or a support). It is also contemplated that the base portion is adapted with a connection mechanism for securing the base portion to additional mounting surfaces (e.g., when securing the base to a post or vertical support having a surface area smaller than the width of the base). The base portion may also include a frame that is connectable to the base portion to cover the base mountings when mounted to a substantially flat surface. The mounting frame has a first opening for surrounding the base portion mounted to the mounting surface, and exposes the holder assembly for ease of use. The mounting frame includes a second opening that is used for interchangeably inserting, for example, informational, promotional, and/or advertising material therein, and holding the material in place. Thus, the area near the combination holder can also be used for advertising, promotion, decoration, or for providing a mirror for the user who has stowed their beverage and purse in and on the holder.

Another aspect of the present disclosure relates to a method of providing a combination holder in any private or public facility. The method comprises providing a combination beverage container and accessory holder as described above, and securing the base portion of the combination holder to the substantially vertical surface with screws or similar fasteners. For example, the mounting surface may be substantially flat. The method then may further comprise providing a mounting frame and securing the mounting frame over and around the base portion, where an opening in the frame exposes the base portion for use. The mounting frame also includes a second opening and the method further comprises inserting advertising or promotional material, or a mirror into the second opening in the frame.

### BRIEF DESCRIPTION OF THE DRAWINGS

FIG. 1 is a front perspective view of an assembled mountable holder of the present disclosure.

FIG. 2 is a top view the assembled mountable holder.

FIG. 3 is a perspective of a mountable holder assembly of the present disclosure.

FIG. 4 is a perspective view of a combination holder of the mountable holder assembly.

FIG. 5 is a top view of the combination holder illustrated in FIG. 5.

FIG. 6 is a perspective view of another combination holder of the mountable holder assembly.

FIG. 7 is a top view of the combination holder illustrated in FIG. 7.

FIG. 8 is a perspective view of a mountable holder and mounting mechanism.

### DETAILED DESCRIPTION

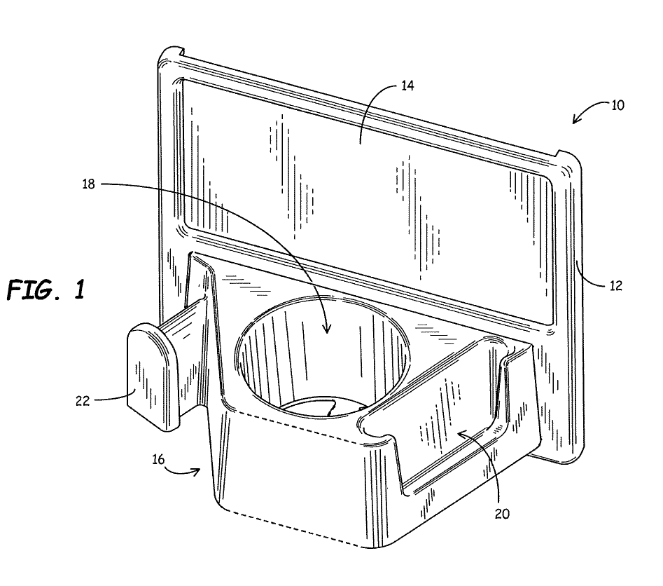

A mountable holder assembly is illustrated generally at 10 in FIG. 1. The mountable holder assembly 10 comprises a mounting frame 12 and a combination holder 16, where the mounting frame 12 is connectable with the combination holder 16. The combination holder 16 comprises a base portion 16 that includes a holder 18 for a beverage container, also referred to herein as a cup holder, a holder 20 for a mobile device or other accessory, and a holder 22 for a bag or purse strap.

The assembly 10 is mountable to a substantially flat surface, examples of which include but are not limited to, a wall or other surface such as the inside wall of a stall in a public restroom. The assembly 10 is mountable to hold or otherwise support a beverage container in a substantially upright position.

The assembly 10 may be constructed of a molded plastic. Other materials for forming the assembly 10, the frame 12 and the base portion 16 can be used. The mounting frame 12 is, as illustrated in the figures, a molded plastic frame 12. The frame 12 may alternatively be constructed of aluminum or other durable, light weight materials. The frame 12 is generally rectangular in shape, but could be formed in any overall geometric shape. The frame 12 includes two openings 11, 13. A first opening 11 receives the combination holder 16 there through. The second opening 13 is configured for insertion of a display 14, where the display may be replaceable advertisements, informational materials or other announcements. While informational or advertising material is described herein, other displays may be inserted into the second opening 13 in the frame 12, non-limiting examples of which include a mirror or decorative materials. The display 14 can be interchangeably inserted into the frame and displayed with the combination holder 16, without having to remove the base 16 from connection with the mounting surface.

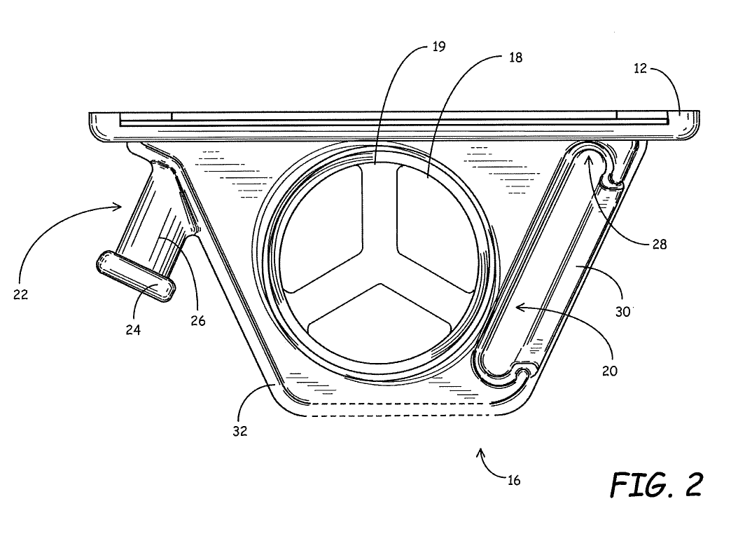

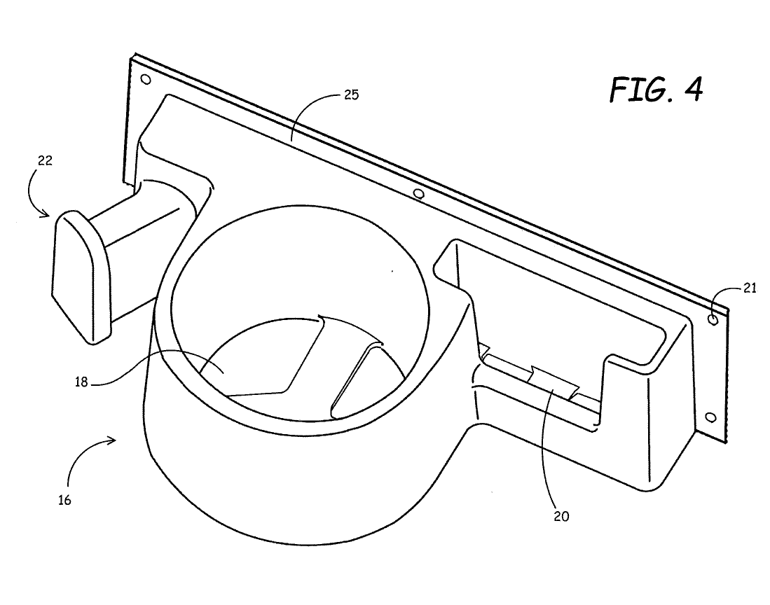

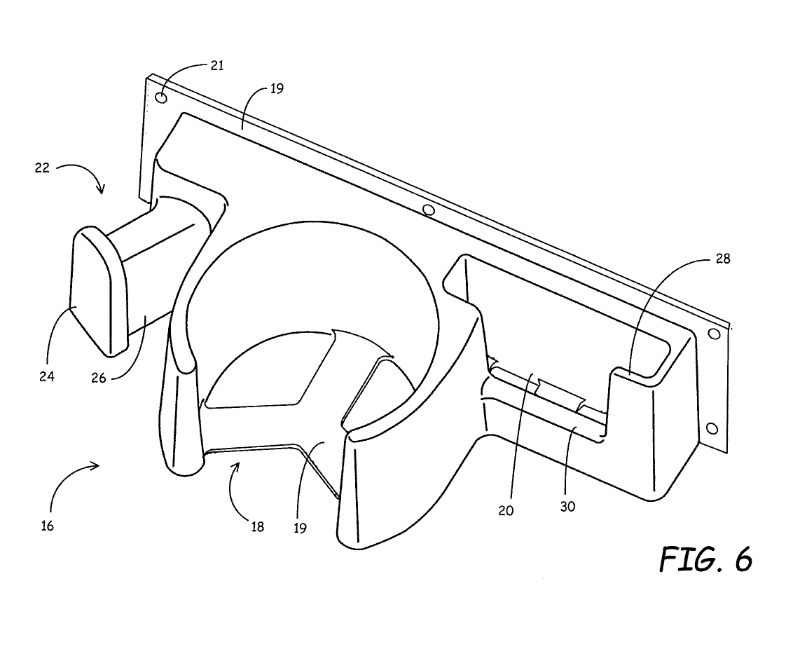

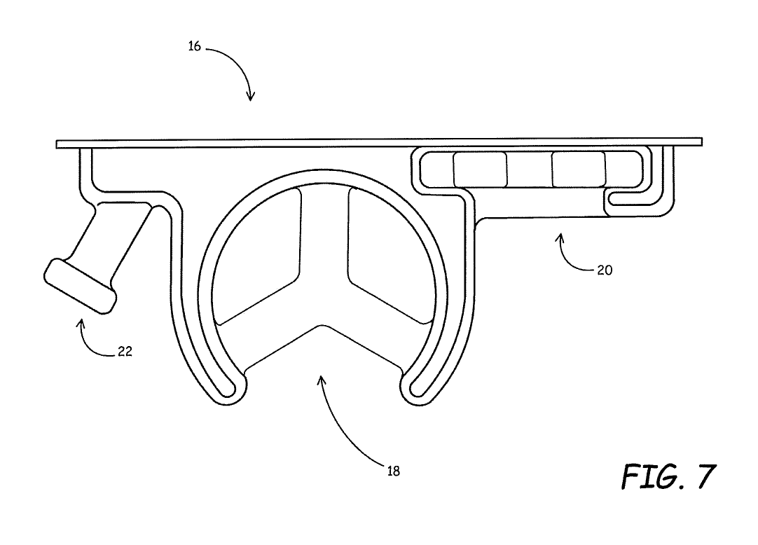

As illustrated in FIGS. 2-8, the combination holder 16 has a base having an integral cup holder 18, integrally formed with a mobile device holder 20 and integrally formed with a bag holder 22. While a beverage container or cup holder, mobile device holder and bag hook are disclosed herein, holders for other accessories are within this disclosure and the holder may be used to hold or retain objects of any shape capable of being received by one or more of the holders 18, 20, 22.

The base 16 is generally rectangular in shape, having a vertical height and depth that extends from a front face of the base 16 to a back face of the base 16. The height and the depth of the base 16 may vary, but are sufficient to accommodate a cavity for the holder 18, a cavity for the holder 20 and accommodate the prong for holder 22.

The beverage container or cup holder 18 is an integrally formed cavity 18 extending downwardly into the base, from an upper surface of the base 16. The cup holder 18 may be positioned generally in the center of the base 16. The holder 22 for holding a strap of a bag or purse and a slot 20 for receiving and supporting a mobile device such as a cell phone are preferably positioned on either side of the cavity for the cup holder 18.

The cup holder 18 extends downwardly into the base 16 such that that a substantially circular wall formed within the base 16 provides a perimeter to the cavity for the cup holder 18. This wall may be tapered to support a beverage container or a cup in a substantially upright position. A floor 19 may be provided to the cup holder 18 to support beverage containers of different dimensions within the cup holder 18 in a substantially upright position. As illustrated in the figures, the floor 19 comprises one or more supports such that the floor 19 has apertures therein. This allows for drainage of condensation from cold or hot beverage containers and allows for easy cleaning of the cup holder 18.

The holder 20 for holding a mobile device or cell phone is preferably a slot also integrally formed within the base portion 16 and also extending downwardly from the upper surface of the base portion 16. The holder 20 may be a rectangular opening with a floor 30 and a perimeter wall 28, which define the shape of the holder 20. The floor 30 and the perimeter wall 28 also support the device received therein in a substantially vertical position. While the holder 20 is described as generally rectangular in shape, other shapes may be utilized.

The bag holder 22 preferably comprises an arm section 26 having a selected length that extends outwardly from the back surface of the base 16. The arm section 26 terminates at a distal end in a vertical end plate 24 that acts as a retainer by having a cross-sectional dimension that is greater than a cross-sectional dimension of the arm section 26. The end plate 24 provides a barrier to the bag strap thereby preventing the bag strap from sliding off of the holder 22. Another non-limiting example of a configuration for the bag holder 22 is a hook or “J” shape. However alternative configurations may also be used. Other means of retaining the bag strap such as downwardly inclining the holder 22 towards the frame are also included in this disclosure.

The holders 18, 20 and 22 are integrally formed and may be formed when the base is molded. To conserve on weight and material used to form the assembly 10, the walls defining each holder 18, 20, and 22 define a hollow interior volume.

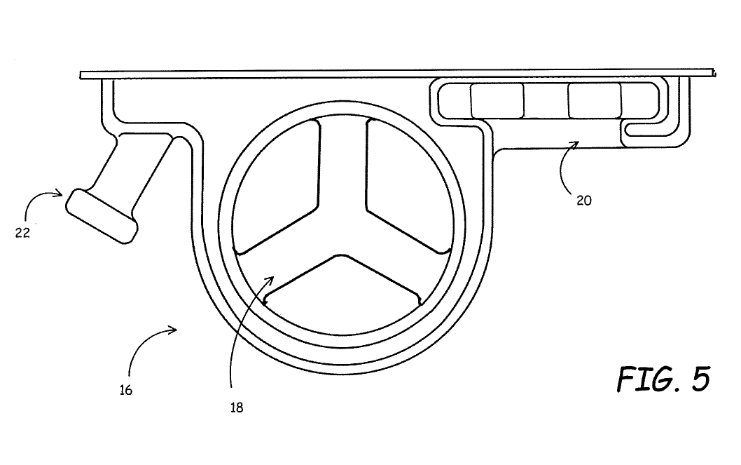

A back surface 23 of the base portion 16—comprises a perimeter wall extending beyond or around the dimensions of the base portion 16. The back surface 23 includes a mounting surface, which is adapted with apertures 21 configured to receive fasteners, such as screws, for mounting the base 16 to the selected wall or other vertical surface such as a back of a seat, bench, or pew. Other non-limiting examples of vertical surfaces include vertical surfaces of cubicles, stalls, carrels, nooks, counters, berths, and small living quarters such as tiny houses, studio apartments, or efficiency apartments. As illustrated in FIG. 5, the apertures 21 are positioned in the corners of the back surface 23. While screws are disclosed herein as a mechanism for securing the base portion 16 to the mounting surface, other fasteners may be used. Adhesives may also be used to secure the base portion 16 and/or the mounting frame 12 to the mounting surface.

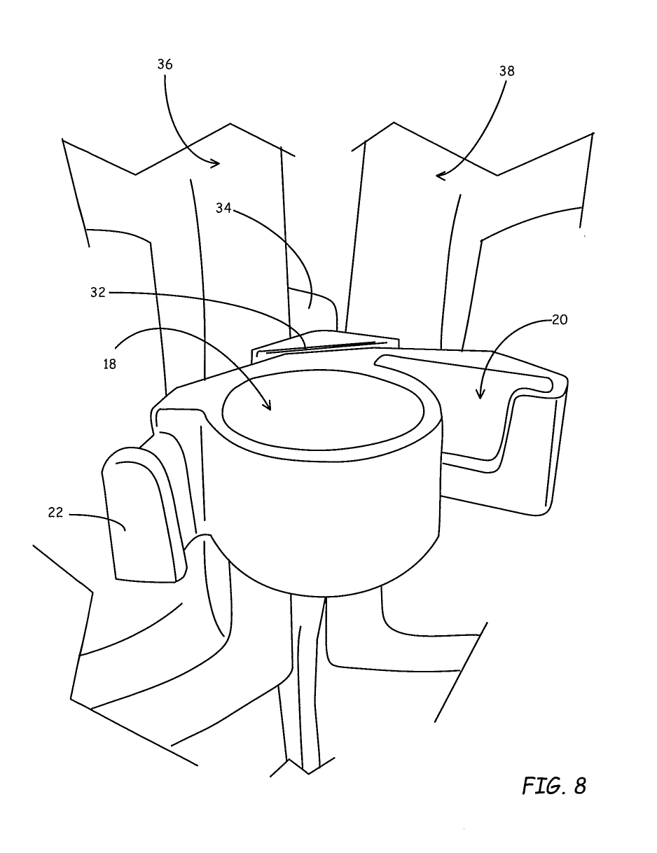

As illustrated in FIG. 8, the back surface may be configured for connection with a mounting mechanism 32 and may have a perimeter shape 34 which allows the mountable holder to be mounted in a generally upright position and near or mounted to surfaces having dimensionality, such as chair backs. The perimeter shape 34 may orient the bag holder 22 and the holder 20 of the base 16 at an angle with respect to the beverage container holder 18. This provides a more compact mountable holder base 16 for fitting between two adjacent seat backs typically found in stadium-type seating rows. The backs of stadium seats are typically curved with curvatures of two adjacent seats converging at angles of less than 180°.

The base 16 is secured to the mounting mechanism 32. The mounting mechanism is configured to secure the base 16 in the upright position to the mounting surface. In the embodiment illustrated, the mounting mechanism is a mounting adapter 32. The mounting adapter 32 is secured to the back surface of the base 16 and is configured such that an opposing side of the mounting adapter 32 is then securely mountable to a substantially vertical support 36, where the support 36 may be an arm rest or other substantially vertical support element positioned between two adjacent seat backs 38 and 40. The mounting adapter is configured with a surface area such that the a first surface area mates with the corresponding back surface of the perimeter shape 34 of the base to sufficiently support the base 16 in the upright position. The opposing side of the mounting adapter 32 has a surface area configured with a mount such that it is securely mountable to the support 36.

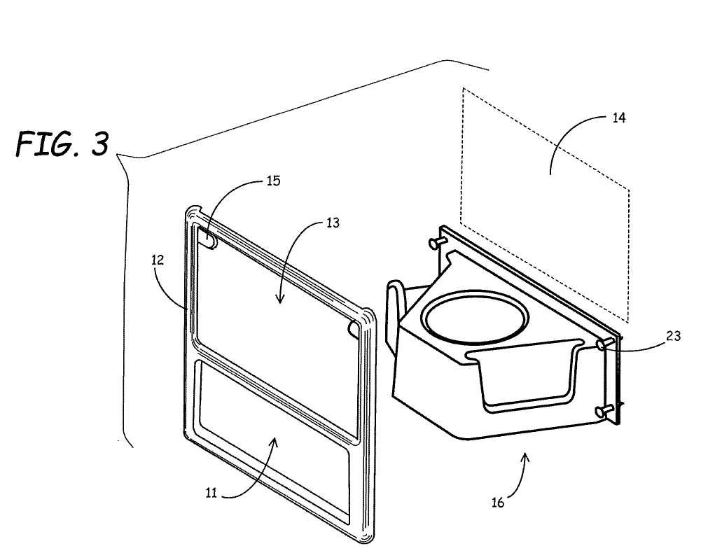

Referring back to FIG. 3, the base portion 16 is secured in an upright position to the selected mounting surface such that the optional mounting frame 12 can be placed over the base portion 16, such that the base portion 16 protrudes through the opening 11 of the mounting frame 12. The mounting frame 12 includes a perimeter surface, that may preferably have rounded edges, and in which the perimeter surface covers the back surface 23 of the base portion 16 when the assembly is mounted to the vertical surface or wall. The second opening 13 in the frame 12 is for displaying advertisements or other materials therein. The second opening 13 also includes tabs 15 on opposing sides thereof. These tabs 15 allow the display 14 to be inserted behind the frame 12 and above the base 16 such that an outer surface of the display 14 is visible through the second opening 13. An upper portion of the second opening, when the assembly is mounted to the generally vertical surface or wall is configured to allow for insertion and interchanging of display elements 14 without requiring removal of the frame 12 or the base 16 from the mounting surface. The tabs 15 also hold the display in place, while allowing for this selective replacement of the interchangeable display 14.

The frame 12 is configured with a back surface edge such that the frame 12 can snap or otherwise interlock into connection with the base 16 along the back surface 23. The frame 12 covers the attachment points 21, 23 of the base portion 16 to the wall and also covers the edges of the display 14 inserted into the second opening 13 in the frame 12.

The combination holder 10 can be mounted in any space where a surface for holding multiple items, including a beverage holder, mobile device holder, and bag holder is present.

Although the present disclosure has been described with reference to preferred embodiments, workers skilled in the art will recognize that changes may be made in form and detail without departing from the spirit and scope of the disclosure.

1. A mountable combination holder assembly comprising:
a base portion having a selected height and a depth, wherein the base portion is configured with a first cavity therein capable of holding a beverage container in a substantially upright position, a second cavity therein capable of holding an accessory therein and an arm section extending from a surface of the base portion for supporting a flexible strap of an object, wherein the base portion has a back surface configured with one or more mounting mechanisms;
a frame portion removably connectable to the base portion and extending upwardly from a connection with the base portion, and wherein the frame portion comprises a first opening and a second opening in a vertical surface of the frame, the first opening configured for connection with the base portion by inserting the base portion into or through the first opening and the second opening configured to receive a display; and
wherein the assembly is mountable to a substantially vertical surface.

2. (canceled)

3. The mountable combination holder assembly of claim 1, wherein the one or more mounting mechanism includes an adapter secured to a back surface of the base portion and connectable to a substantially vertical support surface, wherein the support surface is positioned between two adjacent seat backs.

4. The mountable combination holder assembly of claim 1, wherein the base portion comprises a molded plastic base.

5. The mountable combination holder assembly of claim 1, wherein
the frame comprises a molded plastic frame.

6. The mountable combination holder assembly of claim 1, wherein the second opening in the frame is configured to receive a display comprising advertising material, informational material, a mirror or a combination thereof.

7. The mountable combination holder assembly of claim 6, wherein the second opening comprises tabs on opposing sides thereof for retaining a display therein.

8. The mountable combination holder assembly of claim 1, wherein the first cavity is defined by an integrally formed wall within the base portion.

9. The mountable combination holder assembly of claim 8, wherein the wall is tapered to support the beverage container in a generally upright position.

10. The mountable combination holder assembly of claim 8, wherein the first cavity has a floor for supporting the beverage container in the substantially upright position.

11. The mountable combination holder assembly of claim 1, wherein the second cavity has an integrally formed wall within the base and a floor for supporting an accessory in a generally upright position.

12. The mountable combination holder assembly of claim 1, wherein the arm section extends outwardly from an integral connection with the base.

13. A method of mounting a combination holder to a substantially vertical surface, the method comprising:
providing a base portion having a height and a depth, wherein the base portion is configured with a first cavity therein for supporting a beverage container therein and a second cavity therein for supporting an accessory therein and an arm section extending therefrom for supporting an accessory thereon;
providing a frame having a first opening and a second opening in a vertical surface thereof;
connecting the frame to the base portion by inserting the base portion through the first opening such that the base portion extends from the frame and through the first opening; and
mounting the base portion to the vertical surface by fastening the base portion to the substantially vertical surface that is also substantially flat.

14. The method of claim 13, and further comprising
inserting a display into the second opening in the frame and securing the display therein.

15. The method of claim 13, wherein mounting the base portion comprises providing a mounting adapter secured to a back surface of the base portion and connecting an opposing side of the adapter to a substantially vertical support surface, wherein the support surface is positioned between two adjacent seat backs.

16. The method of claim 13, wherein the display is advertising material, informational material, a mirror or a combination thereof and securing the display comprises inserting the display between the frame and one or more tabs extending from a back surface of the frame near the second opening.

17. The method of claim 13, and further comprising placing a beverage container in the first cavity and supporting the beverage container in a generally upright position therein.

18. The method of claim 16, and further comprising placing a communications device in the second cavity and supporting the communications device in a generally upright position therein.

19. The method of claim 16, and further comprising using the arm section to hold a strap of a bag.
